(19) United States
(12) Patent Application Publication
(10) Pub. No.: US 2020/0301439 A1
(43) Pub. Date: Sep. 24, 2020

(54) INFORMATION PROCESSING APPARATUS AND READING SYSTEM

(71) Applicant: TOSHIBA TEC KABUSHIKI KAISHA, Tokyo (JP)

(72) Inventor: Seiji SAITO, Mishima Shizuoka (JP)

(21) Appl. No.: 16/677,517

(22) Filed: Nov. 7, 2019

(30) Foreign Application Priority Data
Mar. 20, 2019 (JP) 2019-052937

(51) Int. Cl. G05D 1/02; G01S 17/89; G06K 7/10

(52) U.S. Cl. CPC G05D 1/0231; G06K 7/10376; G01S 17/89

(57) ABSTRACT

An information processing apparatus includes an interface circuit through which detection data from a sensor are received, and a processor configured to generate a first environment map based on first detection data received from the sensor, convert the first environment map into a second environment map by a predetermined image processing, generate a third environment map based on second detection data received from the sensor, convert the third environment map into a fourth environment map by the predetermined image processing, compare the second environment map with the fourth environment map, and determine which one of the second environment map and the fourth environment map captures an outline of an object depicted in the second environment map and the fourth environment map according to a comparison result between the second environment map and the fourth environment map.

### CROSS-REFERENCE TO RELATED APPLICATIONS

This application is based upon and claims the benefit of priority from Japanese Patent Application No. 2019-052937, filed on Mar. 20, 2019, the entire contents of which are incorporated herein by reference.

### FIELD

Embodiments of the present invention relate to an information processing apparatus and a reading system.

### BACKGROUND

In recent years, a reading system for reading wireless tags such as RFID (Radio Frequency Identification) tags has been developed for commercial use. One such reading system includes a self-propelled robot and an antenna, and reads the wireless tags while passing in front of a fixture such as a shelf on which a plurality of articles with the wireless tags attached thereto are displayed.

Prior to reading the wireless tags, the reading system generates an environment map to guide the self-propelled robot. For example, the reading system generates the environment map while scanning a surrounding by a laser range finder (LRF) fixed at a predetermined height of the self-propelled robot.

However, the shelf has a plurality of shelf boards horizontally extending and forms an uneven structure. The shape of the shelf detected by the LRF fixed to a given height of the self-propelled robot may differ from the shape obtained by projecting the actual shelf in a vertical direction relative to the horizontal plane. Since the self-propelled robot moves using the environment map, it may collide with a portion of the shelf that is not represented in the environment map.

### BRIEF DESCRIPTION OF THE DRAWINGS

FIG. 1 is a diagram illustrating a reading system according to an embodiment.

FIG. 2 is a schematic diagram illustrating an example configuration of a reading system according to an embodiment.

FIG. 3 is a block diagram illustrating an example configuration of a reading system according to an embodiment.

FIG. 4 is a diagram showing an example of an object detected by the self-propelled robot at a first height.

FIG. 5 is a diagram illustrating a first environment map.

FIG. 6 is a diagram illustrating a second environment map.

FIG. 7 is a diagram showing an example of an object detected by the self-propelled robot at a second height.

FIG. 8 is a diagram illustrating a third environment map.

FIG. 9 is a diagram illustrating a fourth environment map.

FIG. 10 is a flowchart illustrating an example of an operation for generating an environment map by the reading system according to the embodiment.

FIG. 11 is a flowchart illustrating an example of a comparison operation and a determination operation carried out by the reading system according to the embodiment.

FIG. 12 is a flowchart showing another example of a comparison operation and the determination operation carried out by the reading system according to the embodiment.

### DETAILED DESCRIPTION

According to an embodiment, the information processing apparatus includes an interface circuit through which detection data from a sensor are received, and a processor configured to generate a first environment map based on first detection data received from the sensor, convert the first environment map into a second environment map by a predetermined image processing, generate a third environment map based on second detection data received from the sensor, convert the third environment map into a fourth environment map by the predetermined image processing, compare the second environment map with the fourth environment map, and determine which one of the second environment map and the fourth environment map captures an outline of an object depicted in the second environment map and the fourth environment map according to a comparison result between the second environment map and the fourth environment map.

Hereinafter, an embodiment will be described in detail with reference to the accompanying drawings.

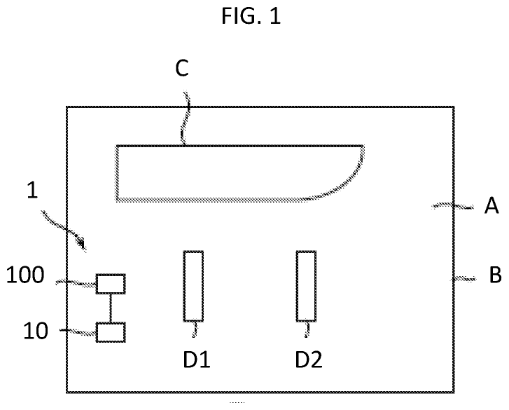

FIG. 1 is a diagram illustrating a reading system 1. The reading system 1 is a system that reads a plurality of wireless tags in a region where a plurality of wireless tags are present. For example, the reading system 1 may be used for stock checking in a store equipped with a plurality of shelves.

Here, the reading system 1 reads the wireless tags in a predetermined region A. One example of the region A is a store surrounded by a wall B. In the region A, there are a register table C, a shelf D1 and a shelf D2. The shelf D1 and the shelf D2 are assumed to have the same form. A plurality of objects each having a wireless tag to be read by the reading system 1 attached thereto, are displayed on the shelf D1 and the shelf D2. Each of the wall B, the register table C, the shelf D1 and the shelf D2 is an example of a tangible object. In addition, the objects other than the wall B, the register table C, the shelf D1, and the shelf D2 may be present in the region A. Some of the objects may be obstacles.

The reading system 1 comprises a system controller 10 and a self-propelled robot 100. The system controller 10 and the self-propelled robot 100 are electrically connected to each other.

The system controller 10 controls the reading system 1. The system controller 10 generates an environment map of the region A prior to a reading operation of the plurality of wireless tags in the region A. The region A is a target area where a plurality of wireless tags are read by the reading system 1. The region A also includes a target area for which the environment map is generated by the reading system 1.

The environment map includes information that indicates the position of the objects existing in a region in which the self-propelled robot 100 moves automatically. The environment map is a two dimensional map along a horizontal plane at an arbitrary height. For example, the environment map contains information indicating the positions of the wall B, the register table C, the shelf D1 and the shelf D2 that are present in the region A. The environment map is used to guide the automatic movement of the self-propelled robot 100 in region A.

The system controller 10 controls the movement of the self-propelled robot 100 and the reading of a plurality of wireless tags using the environment map. The system controller 10 is an example of an information processing apparatus. The system controller 10 will be described later.

The self-propelled robot 100 moves in the region A under the control of the system controller 10. The self-propelled robot 100 will be described later.

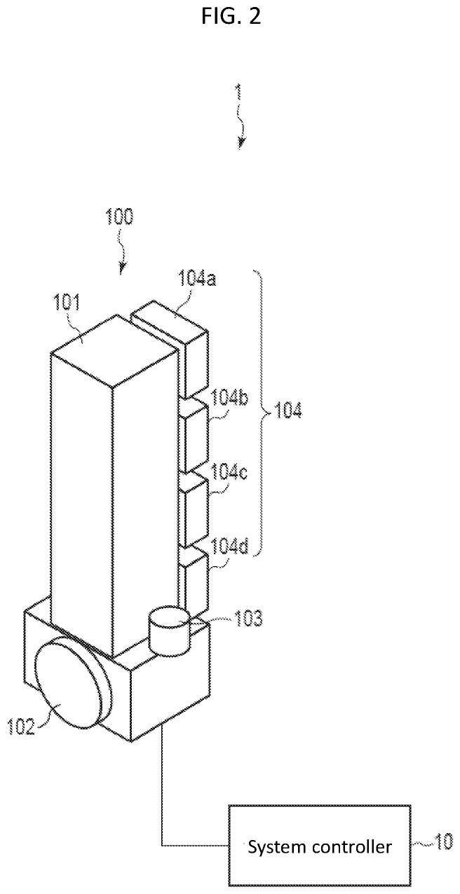

FIG. 2 is a schematic diagram showing an example of the configuration of the reading system 1.

The self-propelled robot 100 includes a housing 101, wheels 102 (only one of which is shown), a sensor 103, and an antennas 104a-104d.

The housing 101 forms an outer shell of the self-propelled robot 100. The wheels 102, the sensor 103, and the antennas 104a-104d are attached to the housing 101.

The wheels 102 are attached to a lower portion of the housing 101. The wheels 102 are driven by a motor 202, which will be described later, to move the housing 101. Further, the wheels 102 change the movement direction of the housing 101.

The sensor 103 detects objects that are in a detection range of the sensor 103. For example, the sensor 103 may be an LRF. The LRF is an example of a laser rangefinder. The sensor 103 scans a surrounding area of the sensor 103 horizontally using a laser and measures a distance between the sensor 103 and the each of the objects existing in the region A. The sensor 103 transmits detection data to the system controller 10. The detection data is used to generate the environment map. The detection data is used to detect the objects that may hinder the self-propelled robot 100 when the self-propelled robot 100 is moving while reading the plurality of wireless tags. The sensor 103 may be any rangefinder that uses a laser. In addition, the sensor 103 may use some other light source other than a laser.

The position of the sensor 103 in the height direction is manually changeable by a user by attaching the sensor 103 at a different position or sliding the sensor 103 along a rail (not shown). Alternatively, the position of the sensor 103 in the height direction may be automatically changed by controlling a moving mechanism (not shown) for the sensor 103 by a processor 11.

The antennas 104a-104d are formed in series from an upper portion to a lower portion of the housing 101. The antennas 104a-104d are formed in the housing 101 so as to face the direction orthogonal to the movement direction of the self-propelled robot 100. For example, antennas 104a-104d are formed on the left (or right) side with respect to the movement direction of the self-propelled robot 100.

The antenna 104a will be described. The antenna 104a is a device for transmitting and receiving data wirelessly to and from the wireless tags attached to the objects displayed on the shelf D1 and the shelf D2. The antenna 104a transmits radio waves to the wireless tags. The antenna 104a receives the radio waves from the wireless tags. For example, the antenna 104a may be a directional antenna. The detectable range of the antenna 104a is set to a range in which radio waves can be transmitted and received in view an installed condition and characteristics such as directivity of the antenna 104.

The configuration of the antenna 104b, the antenna 104c and the antenna 104d is the same as the antenna 104a, and therefore description thereof will not be repeated. The total detectable ranges of the antennas 104a-104d is set to cover a height between a top and a bottom of the highest shelf existing in the region A. As used herein, any one of antennas 104a-104d may be referred to simply as antenna 104.

The number and the position of the antennas 104 included in the self-propelled robot 100 are not limited to a specific number and configuration. For example, the self-propelled robot 100 may employ one antenna 104 that has a detection range that extends from the top to the bottom of the shelves present in the region A.

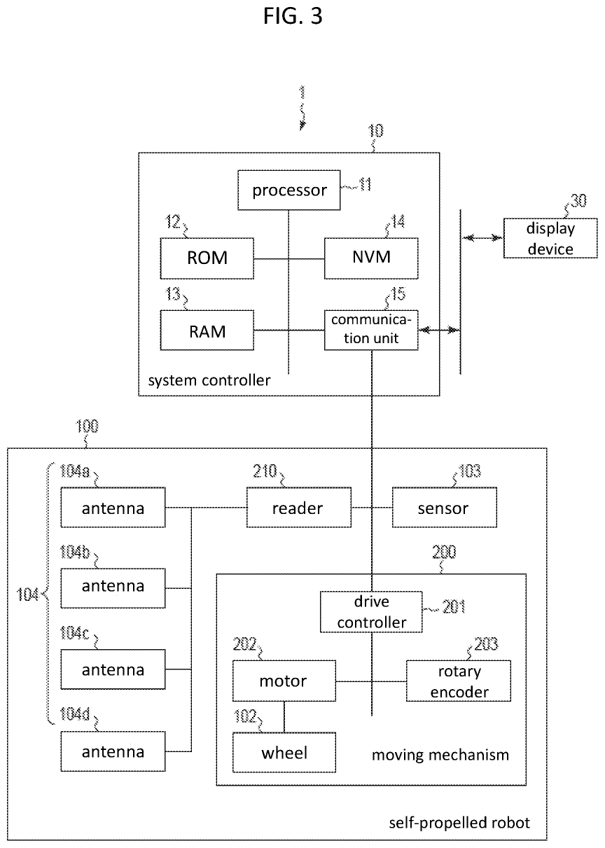

FIG. 3 is a block diagram showing an example of the configuration of the reading system 1.

The system controller 10 includes a processor 11, a ROM (read only memory), a RAM 13(random access memory), an NVM 14 (non-volatile memory), and a communication unit 15. The processor 11, the ROM 12, the RAM 13, the NVM 14, and the communication unit 15 are connected to each other via a data bus.

The processor 11 controls the overall operation of the system controller 10. For example, the processor 11 is a CPU (Central Processing Unit). The processor 11 is an example of a control unit. The processor 11 may include an internal memory and various interfaces. The processor 11 performs various processes by executing programs stored in advance in the internal memory, the ROM 12 or the NVM 14, or the like.

Part of the various functions realized by executing the program by the processor 11 may be realized by a hardware circuit. In such a case, the processor 11 controls the functions to be executed by the hardware circuit.

The ROM 12 is a non-volatile memory that stores control programs, control data, and the like. The ROM 12 is incorporated in the system controller 10 in a state in which the control programs and the control data are stored during the manufacturing stage. That is, the control programs and the control data stored in the ROM 12 are incorporated in advance in accordance with the specifications of the system controller 10.

The RAM 13 is a volatile memory. The RAM 13 temporarily stores data that is being processed by the processor 11. The RAM 13 stores various application programs on the basis of instructions from the processor 11. Also, the RAM 13 may store data necessary for execution of the application program, execution results of the application programs, and the like.

The NVM 14 is a non-volatile memory capable of writing and rewriting data. For example, the NVM 14 includes an HDD (Hard Disk Drive), an SSD (Solid State Drive), an EEPROM (Electrically Erasable Programmable Read-Only Memory), a flash memory, and the like. The NVM 14 stores control programs, applications and various data according to the operational use of the system controller 10. The NVM 14 is an example of a storage unit.

The communication unit 15 is an interface for transmitting and receiving data by wired or wireless communication. For example, the communication unit 15 is an interface circuit that supports a LAN (Local Area Network) connection. The communication unit 15 transmits and receives data to and from the self-propelled robot 100 by wired or wireless communication. The communication unit 15 transmits the data to a display device 30 by wired or wireless communication. For example, the display device 30 is a liquid crystal display, but the present invention is not limited thereto. The display device 30 may be included in the reading system 1 or may be a stand-alone element that is independent from the reading system 1.

The self-propelled robot 100 includes the sensor 103, the antennas 104a-104d, a driving mechanism 200, and a reader 210. The sensor 103 and the antennas 104a-104d are as described above.

The driving mechanism 200 drives the self-propelled robot 100. Since the self-propelled robot 100 comprises the antennas 104a-104d, the driving mechanism 200 is also a mechanism for moving antennas 104a-104d. The driving mechanism 200 includes the wheels 102, a drive controller 201, a motor 202, a rotary encoder 203, and the like. The drive controller 201, the motor 202 and the rotary encoder 203 are electrically connected to each other. The wheels 102 and motor 202 are mechanically connected to each other. The wheels 102 are as described above.

The drive controller 201 drives the self-propelled robot 100 in accordance with the control of the system controller 10. The drive controller 201 controls the motor 202 to move the self-propelled robot 100. For example, the drive controller 201 may control power supplied to the motor 202.

The drive controller 201 includes a processor or the like executing software. Alternatively, the drive controller 201 may be a dedicated hardware circuit, such as an ASIC (Application Specific Integrated Circuit).

The motor 202 is driven in accordance with the control of the drive controller 201. The motor 202 is connected to wheels 102 via gears or belts and the like. The motor 202 generates a driving force for rotating the wheels 102.

The rotary encoder 203 is connected to a rotary shaft of the motor 202. The rotary encoder 203 measures rotation of the motor 202. In particular, the rotary encoder 203 transmits data indicating a rotational angle to the system controller 10. In the following description, the data indicating the rotational angle is also referred to as the rotational angle data. The rotary encoder 203 may be incorporated in the motor 202.

The reader 210 is an interface circuit for transmitting and receiving data by wireless to and from the wireless tags through the antennas 104a-104d. The reader 210 reads tag information of the wireless tags by performing data communication with the wireless tags. For example, the reader 210 transmits a predetermined read command to the wireless tags based on the control of the system controller 10. The reader 210 then receives tag information as a response to the read command. The reader 210 transmits the received tag information to the system controller 10.

The self-propelled robot 100 may be equipped with the system controller 10. The self-propelled robot 100 may also perform a function (or a part of the function) carried out by the processor 11 of the system controller 10.

The reading system 1 may have additional elements other than the elements described above, or some elements may be removed from the reading system 1.

Next, the functions realized by the processor 11 will be described.

The processor 11 performs the functions described below by executing software stored in the ROM 12 or the NVM 14.

The processor 11 has a function of generating the environment map as described below.

First, the processor 11 controls the self-propelled robot 100 to move around in the region A. The processor 11 receives detection data from the sensor 103 in response to the movement of the self-propelled robot 100 in the region A, and receives rotational angle data from the rotary encoder 203. Next, the processor 11 performs simultaneous localization and mapping (SLAM) based on the detection data and the rotational angle data. The processor 11 generates the environment map by performing the SLAM. The processor 11 stores data for the environment map in the NVM 14.

The processor 11 drives the self-propelled robot 100 using the environment map as described below.

First, the processor 11 receives an input to start an operation from the user. Next, the processor 11 acquires a work start position corresponding to the user's input from the NVM 14. Next, the processor 11 acquires the data indicating the environment map from the NVM 14. The processor 11 uses the environment map to determine a route from a current position of the self-propelled robot 100 to the work start position so as not to collide with any object in the region A. Next, the processor 11 uses the environment map to determine a route from the work start position to a target position so as not to collide with any object in the region A.

Then, the processor 11 controls the driving mechanism 200 to move the self-propelled robot 100 following a route from the current position to the work start position. Then, the processor 11 controls the driving mechanism 200 to move the self-propelled robot 100 along the route from the work start position to the target position. The processor 11 may appropriately correct the route in order to avoid any object detected by the sensor 103.

The processor 11 reads wireless tags using the antennas 104 and the reader 210 as described below.

First, the processor 11 determines that the self-propelled robot 100 has reached the work start position based on the detection data and the rotational angle data. Then, the processor 11 starts transmitting a read request to the wireless tags using the antennas 104 and the reader 210 after the self-propelled robot 100 has reached the work start position. The processor 11 transmits the read request to the wireless tags using the antennas 104 and the reader 210 while the self-propelled robot 100 moves from the work start position to the target position. Then, the processor 11 acquires tag information from the wireless tags through the antennas 104 and the reader 210.

Next, a description will be given of an example of determining a position in the height direction of the sensor 103.

The processor 11 determines the position of the sensor 103 in the height direction prior to the reading operation of the plurality of wireless tags by the self-propelled robot 100. Here, the processor 11 compares the environment maps based on the detection data detected by the sensor 103 at a plurality of heights above the floor surface of region A. A plurality of heights may include two heights, a first height, and a second height different from the first height, or may include three heights or more.

First, an example in which the sensor 103 is located at the first height from the floor surface of the region A will be described.

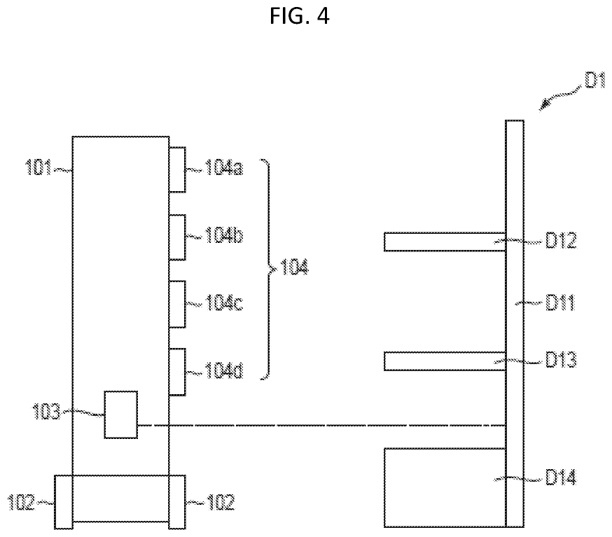

FIG. 4 shows an example of a detection at the first height by a self-propelled robot 100.

FIG. 4 shows an example of detection by the sensor 103. The sensor 103 obtains detection signals at a position where a shelf board D12, a shelf board D13 and a shelf board D14, which are parts of the shelf D1, are fixed.

The shelf D1 has no shelf board at the first height. Therefore, the sensor 103 detects a rear board D11 of the shelf D1 to which the shelf board D12, the shelf board D13, and the shelf board D14 are fixed.

The processor 11 operates as the first acquisition unit, the first generation unit, and the first conversion unit, according to programs executed therein, in connection with the detection at the first height by the sensor 103.

The processor 11, as a first acquisition unit, acquires a first detection data associated with the detection at the first height from the sensor 103. The first detection data is detected by the sensor 103 located at the first height. The first detection data is detection data related to detection of all objects present in the region A at the first height. For example, the processor 11 acquires the first detection data from the sensor 103 in response to the movement of the self-propelled robot 100 in the region A.

The processor 11, as a first generation unit, generates a first environment map M1 based on the first detection data.

For example, the processor 11 generates the first environment map M1 by SLAM based on the first detection data. The processor 11 generates the first environment map M1 using the rotational angle data in addition to the first detection data.

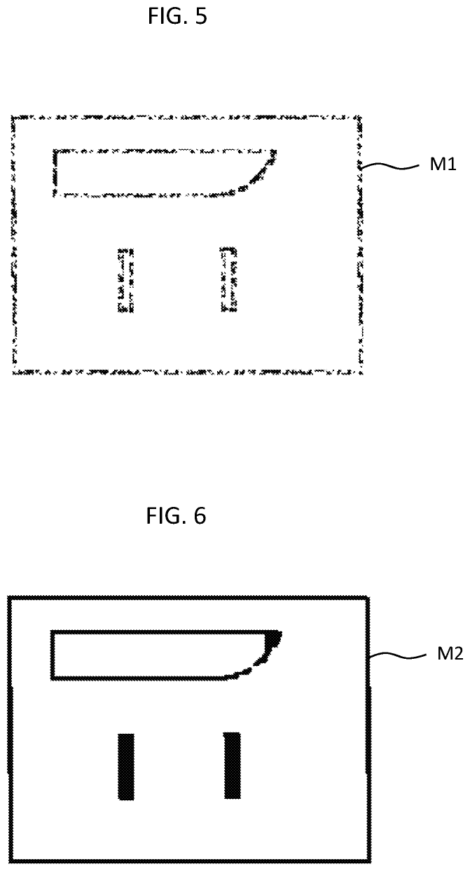

FIG. 5 is a diagram illustrating the first environment map M1. The first environment map M1 is a binary image.

Black pixels that make up the first environment map M1 indicates a portion detected by the sensor 103 in the region A. Therefore, the black pixels that make up the first environment map M1 mainly indicates the objects existing in the region A. White pixels that make up the first environment map M1 indicates a portion that is not detected by the sensor 103 in the region A. Therefore, the white pixels that make up the first environment map M1 mainly indicates a space other than the objects in the region A. The white pixels that make up the first environment map M1 may, however, indicate a portion of the objects in the region A that is not detected by the sensor 103. The portion of the objects that is not detected by the sensor 103 can be said to be a portion that is not captured by the sensor 103. The image that is expressed by the black pixels and the white pixels may be reversed.

An outer periphery (outer edge) of the portion corresponding to the shelf D1 drawn in the first environment map M1 is partially missing. The shelf D1 is not drawn in the first environment map M1 to an extent enough to define clearly the outer periphery of shelf D1. The same is true for the wall B, the register table C, and the shelf D2.

In the first environment map M1, the rear board D11 of shelf D1 is drawn, but no shelf board of shelf D1 is drawn. Therefore, a shape of the portion corresponding to shelf D1 drawn in the first environment map M1 is different from an actual outline of the shelf D1. Here, the shelf D1 has a two dimensional shape obtained by projecting shelf D1 onto a horizontal plane or the maximum two dimensional shape of the shelf D1 along the horizontal plane. Since the sensor 103 has not detected any shelf board, the shape corresponding to shelf D1 drawn in the first environment map M1 is smaller than the outline of shelf D1.

The processor 11, as a first conversion unit, converts the first environment map M1 into a second environment map M2 by a predetermined image processing.

Here, the predetermined image processing is an expansion/contraction processing. For example, the expansion/contraction processing applies morphology. For example, processor 11 replaces eight pixels surrounding each black pixel with black pixels, and then replaces the eight pixels surrounding each white pixel with white pixels. Thus, the number of the black pixels is increased by the former processing, and is reduced by the latter processing. The expansion/contraction processing is not limited to the method described here, and various methods can be applied. The predetermined image processing is not limited to the expansion/contraction processing.

For example, the processor 11 converts the first environment map M1 into the second environment map M2 by subjecting the first environment map M1 to the expansion/contraction processing. The processor 11 stores the data indicating the second environment map M2 in the NVM 14.

FIG. 6 is a diagram illustrating the second environment map M2. The second environment map M2 is a binary image.

In the second environment map M2 shown in FIG. 6, missing pixels of the outer periphery of the shelf D1 are complemented with black pixels by subjecting the first environment map M1 to the expansion/contraction processing. The shelf D1 is drawn with black pixels in the second environment map M2 to an extent enough to define clearly the outline of the shelf D1. The same is true for the wall B, the register table C, and the shelf D2.

Next, an example in which the sensor 103 is positioned at a second height from the floor surface of the region A will be described.

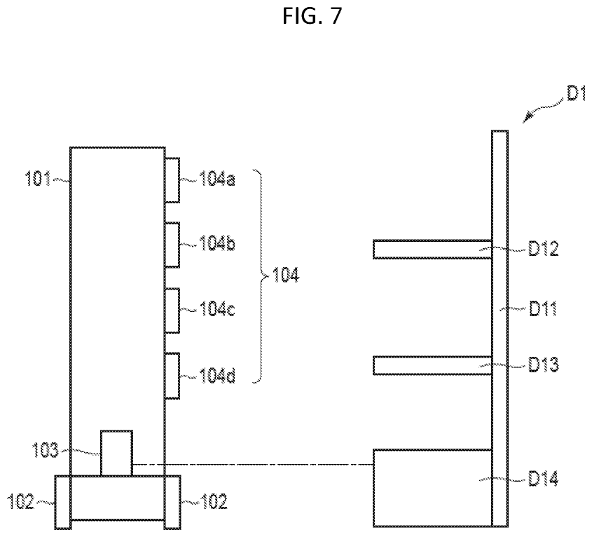

FIG. 7 shows an example of a detection at a second height by the self-propelled robot 100. FIG. 7 shows an example of a detection by the sensor 103 at a position where one of the shelf board D12, the shelf board D13 and the shelf board D14 exists.

The shelf D1 has the shelf board D14 at the second height. Therefore, the sensor 103 detects the shelf board D14 of the shelf D1 at the position where each of the shelf board D12, the shelf board D13, and the shelf board D14 exists.

The processor 11 operates as a second acquisition unit, a second generation unit, and a second conversion unit, according to programs executed therein, in connection with the detection at the second height by the sensor 103.

The processor 11, as the second acquisition unit, acquires a second detection data associated with the detection at the second height from the sensor 103. The second detection data is data detected by the sensor 103 located at the second height. The second detection data is data related to detection of all objects present in the region A at the second height. For example, the processor 11 acquires the second detection data from the sensor 103 in response to the movement of the self-propelled robot 100 in the region A.

The processor 11, as the second generation unit, generates a third environment map M3 based on the second detection data.

For example, the processor 11 generates the third environment map M3 by the SLAM based on the second detection data. The processor 11 generates the third environment map M3 using the rotational angle data or the like in addition to the second detection data.

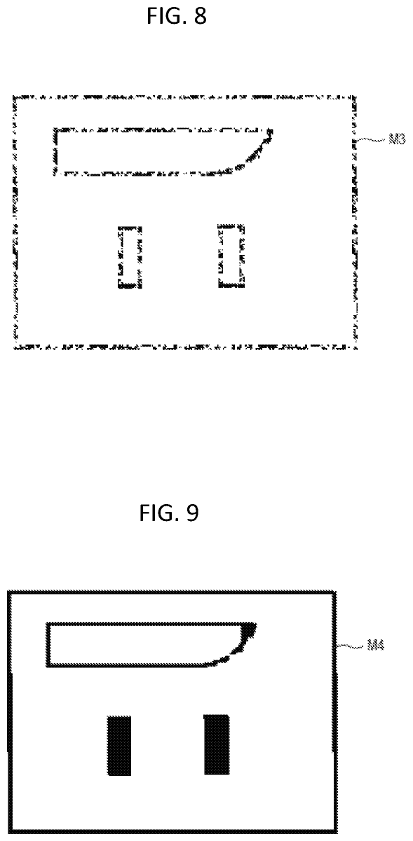

FIG. 8 is a diagram illustrating a third environment map M3.

The third environment map M3 is a binary image. Black pixels that make up the third environment map M3 indicates a portion detected by the sensor 103 in the region A. Therefore, the black pixels that make up the third environment map M3 mainly indicates the objects in the region A. The white pixels that make up the third environment map M3 indicates a portion that is not detected by the sensor 103 in the region A. Therefore, the white pixels that make up the third environment map M3 mainly indicates a space other than the objects in the region A. The white pixels that make up the third environment map M3 may, however, indicate a portion of the objects in the region A that is not detected by the sensor 103. A portion of the objects that is not detected by the sensor 103 can be said to be a portion that is not captured by the sensor 103. The image that is expressed by the black pixels and the white pixels may be reversed.

The outer periphery of the portion corresponding to the shelf D1 drawn in the third environment map M3 is partially missing. The shelf D1 is not drawn in the third environment map M3 to an extent enough to define clearly the outer periphery of the shelf D1. The same is true for the wall B, the register table C, and the shelf D2.

In the third environment map M3, the shelf board D14 of shelf D1 is drawn. Therefore, the shape of the portion corresponding to the shelf D1 drawn in the third environment map M3 is same or substantially same as the actual shape of the shelf D1.

The processor 11, as the second conversion unit, converts the third environment map M3 into a second environment map M4 by a predetermined image processing.

Here, the predetermined image processing is the expansion/contraction processing.

For example, the processor 11 converts the third environment map M3 into a fourth environment map M4 by subjecting the third environment map M3 to the expansion/contraction processing. The processor 11 stores the data indicating the fourth environment map M4 in the NVM 14.

FIG. 9 is a diagram illustrating the fourth environment map M4.

FIG. 9 shows the fourth environment map M4. In the fourth environment map M4, missing pixels of the outer periphery of the shelf D1 are complemented with black pixels by the expansion/contraction processing for the third environment map M3. The shelf D1 is drawn with black pixels in the fourth environment map M4 to an extent enough to define clearly the outer periphery of the shelf D1. The same is true for the wall B, the register table C, and the shelf D2.

In order to determine the position of the sensor 103 in the height direction, the processor 11 operates as the comparing unit and a determination unit as described below.

The processor 11, as a comparing unit, compares the second environment map M2 with the fourth environment map M4.

In one example, processor 11 compares the second environment map M2 and the fourth environment map M4 based on the number of pixels in the portion corresponding to the shelf D1 drawn in each environment map. In this example, the processor 11 calculates the number of pixels O₁ of the portion corresponding to the shelf D1 drawn in the second environment map M2. The number of pixels O₁ is the number of the black pixels in the portion corresponding to the shelf D1. The processor 11 calculates the number of pixels O₂ of the portion corresponding to the shelf D1 drawn in the fourth environment map M4. The number of pixel O₂ is the number of the black pixels in the portion corresponding to the shelf D1.

The processor 11 compares the number of pixels O₁ with the number of pixels O₂. As the number of pixels in the portion corresponding to the shelf D1 increases, the shape of the portion corresponding to the shelf D1 drawn in the environment map becomes larger. That is, as the number of pixels in the portion corresponding to the shelf D1 increases, the shape of the shelf D1 drawn in the environment map has more similarity to the actual shape of the shelf D1.

In another example, processor 11 compares the second environment map M2 and the fourth environment map M4 based on the length of the periphery of the portion corresponding to the shelf D1 drawn in the environment map. In this example, the processor 11 calculates the length L₁ of the outer periphery of the portion corresponding to the shelf D1 drawn in the second environment map M2. The processor 11 calculates the length L₂ of the outer periphery of the portion corresponding to the shelf D1 drawn in the fourth environment map M4. Since length L₁ and length L₂ relate to the size of the portion corresponding to the shelf D1, it is also related to the number of black pixels that define the outer periphery of the shelf D1.

The processor 11 compares the length L₁ with the length L₂. As the length of the outer periphery of the portion corresponding to the shelf D1 becomes longer, the shape of the portion corresponding to the shelf D1 drawn in the environment map becomes larger. That is, as the length of the outer periphery of the portion corresponding to shelf D1 becomes longer, the shape of shelf D1 drawn in the environment map has more similarity to the actual shape of the shelf D1.

In the example which compares the lengths of the outer peripheries, the predetermined image processing may be any image processing different from the expansion/contraction processing. The predetermined image processing may be a process of complementing pixels so as to express clearly the outer periphery of the objects drawn in the environment map.

The processor 11, as the determination unit, determines which of the second environment map M2 and the fourth environment map M4 has captured the outer shape the shelf D1 more successfully, according to a comparison result between the second environment map M2 and the fourth environment map M4. Here, capturing the outline of the shelf D1 successfully means that the shape of the shelf D1 drawn in the environment map is same as or substantially same as outline of the actual shelf D1. The environment map that captures the outline of the shelf D1 successfully can be said to be an environment map that is suitable for guiding the movement of the self-propelled robot 100.

First, the comparison result between the second environment map M2 and the fourth environment map M4 based on the number of pixels in a portion corresponding to the shelf D1 drawn in each environment map will be described as an example. When the processor 11 determines that the second environment map M2 has successfully captured the outline of the shelf D1 when the comparison result shows that the number of pixels O₁ is larger than the number of pixels 02, the processor 11 determines that the second environment map M2 is more suitable for guiding the movement of the self-propelled robot 100 than the second environment map M4. On the other hand, when the processor 11 determines that the fourth environment map M4 has successfully captured the outline of the shelf D1 when the comparison result shows that the number of pixels O₂ is larger than the number of pixels O₁, the processor 11 determines that the fourth environment map M4 is more suitable for guiding the movement of the self-propelled robot 100 than the second environment map M2.

Next, a comparison result between the second environment map M2 and the fourth environment map M4 based on the length of the outer periphery of the portion corresponding to the shelf D1 drawn in each environment map will be described as an example. The processor 11 determines that the first environment map M2 has successfully captured the outline of the shelf D1 when the comparison result shows that the length L₁ is longer than the length L₂. In other words, the processor 11 determines that the second environment map M2 is more suitable for guiding the movement of the self-propelled robot 100 than the fourth environment map M4. On the other hand, the processor 11 determines that the fourth environment map M4 has successfully captured the outline of the shelf D1 when the comparison result shows the length L₂ is longer than the length L₁. In other words, the processor 11 determines that the fourth environment map M4 is more suitable for guiding the movement of the self-propelled robot 100 than the second environment map M2.

Although the processor 11 determines the environment map suitable for the drive of the self-propelled robot 100 based on the shape of the shelf D1, it may determine based on any other shelf in the region A.

The processor 11 selects one environment map which the processor 11 has determined has successfully captured the outline of the shelf D1, from the second environment map M2 and the fourth environment map M4, and adopts the selected environment map for guiding the movement of the self-propelled robot 100 in the region A. Therefore, the processor 11 stores data of the selected environment map in the NVM 14 that has been determined to have captured the outline of the shelf D1. On the other hand, the processor 11 does not employ the environment map for guiding the movement of the self-propelled robot 100 in the region A, if the map has been determined to have failed to capture the outline of the shelf D1. Therefore, the processor 11 deletes data stored in the NVM 14 that indicates the environment map that has been determined to have failed to capture the outline of the shelf D1.

Accordingly, the processor 11 controls the self-propelled robot 100 based on one of the second environment map M2 and the fourth environment map M4 that has been determined to have successfully captured the outline of the shelf D1.

The processor 11 outputs signals to show a user the height of the sensor 103 associated with the environment map that has been determined to have successfully captured the outline of the shelf D1. In one example, the processor 11 causes the display device 30 to display information indicating the position of the sensor 103 in the height direction, so that the user can learn the height. In another example, the processor 11 outputs audio signals through a speaker to verbally describe to the user the position in the height direction of the sensor 103. It should be understood that the user is able to move the sensor 103 to an appropriate position.

Alternatively, the processor 11 may control a movable mechanism to move the sensor 103 to the position in the height direction of the sensor 103 associated with the environment map determined to have successfully captured the outline of the objects.

Thus, the position of the sensor 103 in the height direction corresponds to the height related to the detection data that provides a basis for a generation of the environment map that is used to guide the movement of the self-propelled robot 100.

Next, an example of the operation of the processor 11 will be described.

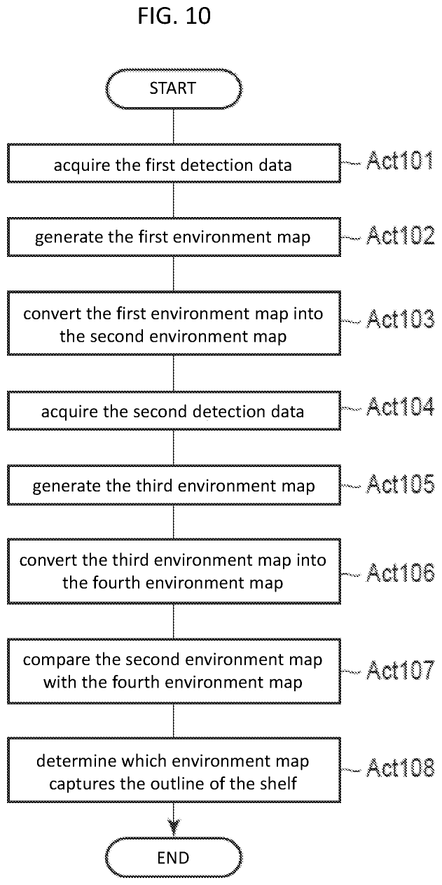

First, FIG. 10 is a flowchart showing an example of the generation of the environment map by the processor 11.

The processor 11 acquires the first detection data associated with the detection at the first height from the sensor 103 (Act 101). The processor 11 generates the first environment map M1 based on the first detection data (Act 102). The processor 11 converts the first environment map M1 into the second environment map M2 by a predetermined image processing (Act 103).

The processor 11 acquires the second detection data associated with the detection at the second height from the sensor 103 (Act 104). The processor 11 generates the third environment map M3 based on the second detection data (Act 105). The processor 11 converts the third environment map M3 into a fourth environment map M4 by the predetermined image processing (Act 106).

The processor 11 compares the second environment map M2 with the fourth environment map M4 (Act 107). In response to the comparison result between the second environment map M2 and the fourth environment map M4, the processor 11 determines which one of the second environment map M2 and the fourth environment map M4 has successfully captured the outline of the shelf D1 or the shelf D2 (Act 108).

According to an embodiment, the reading system 1 can adopt one environment map capturing the outline of the objects by determining the environment map that successfully captures the outline of the objects from among a plurality of environment maps. Also, the reading system 1 can drive the self-propelled robot 100 in a state in which the sensor 103 is positioned at an appropriate height. Thus, the reading system 1 can avoid the collision of the self-propelled robot 100 with objects, which may occurs when the sensor 103 has failed to detect the objects.

According to the embodiment, the reading system 1 can perform image processing to a format suitable for determining the environment map that captures the outline of the objects by using the expansion/contraction processing. The reading system 1 can improve the accuracy of determining the environment map that captures the outline of the object.

Next, typical examples of a comparison operation at Act 107 and a determination operation at Act 108 shown in FIG. 10 will be described.

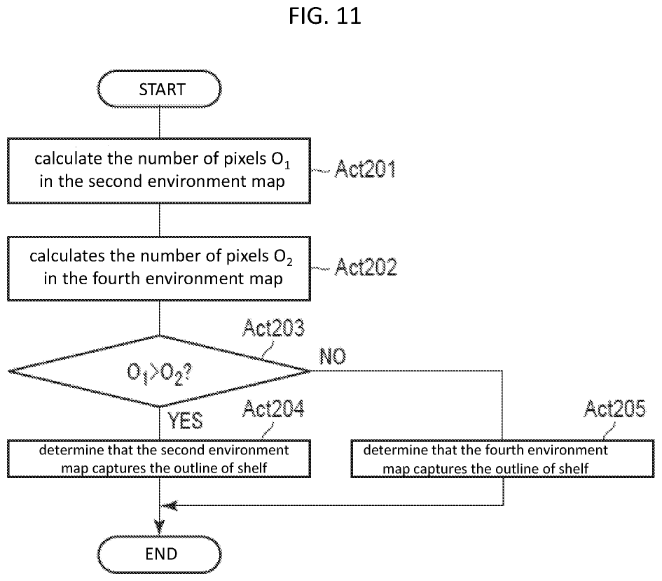

FIG. 11 is a flowchart showing an example of the comparison operation and the determination operation by the processor 11.

The processor 11 calculates the number of pixels O₁ of the portion corresponding to the shelf D1 drawn in the second environment map M2 (Act 201). The processor 11 calculates the number of pixels O₂ of the portion corresponding to the shelf D1 drawn in the fourth environment map M4 (Act 202). The processor 11 compares the number of pixels O₁ with the number of pixels O₂ (Act 203). When the number of pixels O₁ is larger than the number of pixels O₂ (Yes in Act 203), the processor 11 determines that the second environment map M2 captures the outline of the shelf D1 (Act 204). When the number of pixels O₂ is larger than the number of pixels O₁ (NO in Act 203), the processor 11 determines that the fourth environment map M4 captures the outline of the shelf D1 (Act 205).

According to an embodiment, the reading system 1 compares the plurality of environment maps based on the number of pixels in the portion corresponding to the objects. Thus, the reading system 1 can improve the accuracy in determining the environment map that captures the outline of the object.

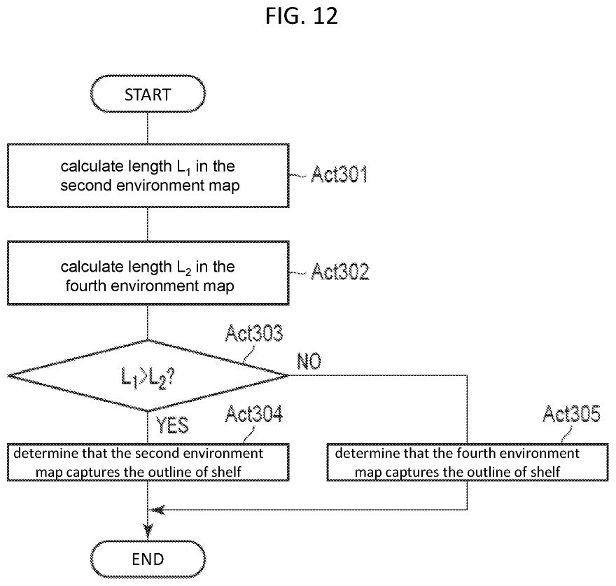

FIG. 12 is a flowchart showing another example of the comparison operation and the determination operation of the environment map by the processor 11.

The processor 11 calculates the length L₁ of the outline of the portion corresponding to the shelf D1 drawn in the second environment map M2 (Act 301). The processor 11 calculates the length L₂ of the outline of the portion corresponding to the shelf D1 drawn in the second environment map M4 (Act 302). The processor 11 compares the length L₁ and the length L₂ (Act 303). When the length L₁ is longer than the length L₂ (Yes in Act 303), the processor 11 determines that the second environment map M2 captures the outline of the shelf D1 (Act 304). When the length L₂ is longer than the length L₁ (No in Act 303), the processor 11 determines that the fourth environment map M4 captures the outline of the shelf D1 (Act 305).

According to an embodiment, the reading system 1 compares the plurality of environment maps based on the length of the outer peripheries of the portion corresponding to the objects. Thus, the reading system 1 can improve the accuracy in determining the environment map that captures the outline of the objects.

The position of the sensor 103 in the height direction is determined by the processor 11 of the system controller 10 as an example. However, the determination of the position of the sensor 103 is not limited to this example. The determination of the position of the sensor 103 in the height direction may be performed by a server connected to the reading system 1. In this case, the server is an example of the information processing apparatus.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
an interface circuit through which detection data from a sensor are received; and
a processor configured to:
generate a first environment map based on first detection data received from the sensor;
convert the first environment map into a second environment map by a predetermined image processing;
generate a third environment map based on second detection data received from the sensor;
convert the third environment map into a fourth environment map by the predetermined image processing;
compare the second environment map with the fourth environment map; and
determine which one of the second environment map and the fourth environment map captures an outline of an object depicted in the second environment map and the fourth environment map according to a comparison result between the second environment map and the fourth environment map.

2. The information processing apparatus according to claim 1, wherein the processor is configured to compare the number of pixels in a first portion of the second environment map that depicts the object with the number of pixels in a second portion of the fourth environment map that depicts the object to generate the comparison result.

3. The information processing apparatus according to claim 2, wherein the processor is configured to
determine that the second environment map captures the outline of the object more accurately than the fourth environment map if the number of pixels in the first portion is greater than the number of pixels in the second portion, and
determine that the fourth environment map captures the outline of the object more accurately than the second environment map if the number of pixels in the second portion is greater than the number of pixels in the first portion.

4. The information processing apparatus according to claim 1, the processor is configured to compare the length of an outer periphery of a first portion of the second environment map that depicts the object with the length of an outer periphery of a second portion of the fourth environment map that depicts the object to generate the comparison result.

5. The information processing apparatus according to claim 4, wherein the processor is configured to
determine that the second environment map captures the outline of the object more accurately than the fourth environment map if the length of the outer periphery of the first portion is greater than the length of the outer periphery of the second portion, and
determine that the fourth environment map captures the outline of the object more accurately than the second environment map if the length of the outer periphery of the second portion is greater than the length of the outer periphery of the first portion.

6. The information processing apparatus according to claim 1, wherein the predetermined image processing is an expansion/contraction processing.

7. The information processing apparatus according to claim 1, wherein the sensor generates the first detection data when the sensor is at a first height and the second detection data when the sensor is at a second height different from the first height.

8. A reading system comprising:
a sensor; and
a controller configured to:
generate a first environment map based on first detection data received from the sensor;
convert the first environment map into a second environment map by a predetermined image processing;
generate a third environment map based on second detection data received from the sensor;
convert the third environment map into a fourth environment map by the predetermined image processing;
compare the second environment map with the fourth environment map; and
determine which one of the second environment map and the fourth environment map captures an outline of an object depicted in the second environment map and the fourth environment map according to a comparison result between the second environment map and the fourth environment map.

9. The reading system according to claim 8, wherein the controller is configured to compare the number of pixels in a first portion of the second environment map that depicts the object with the number of pixels in a second portion of the fourth environment map that depicts the object to generate the comparison result.

10. The reading system according to claim 9, wherein the controller is configured to
determine that the second environment map captures the outline of the object more accurately than the fourth environment map if the number of pixels in the first portion is greater than the number of pixels in the second portion, and
determine that the fourth environment map captures the outline of the object more accurately than the second environment map if the number of pixels in the second portion is greater than the number of pixels in the first portion.

11. The reading system according to claim 8, the controller is configured to compare the length of an outer periphery of a first portion of the second environment map that depicts the object with the length of an outer periphery of a second portion of the fourth environment map that depicts the object to generate the comparison result.

12. The reading system according to claim 11, wherein the controller is configured to
determine that the second environment map captures the outline of the object more accurately than the fourth environment map if the length of the outer periphery of the first portion is greater than the length of the outer periphery of the second portion, and
determine that the fourth environment map captures the outline of the object more accurately than the second environment map if the length of the outer periphery of the second portion is greater than the length of the outer periphery of the first portion.

13. The reading system according to claim 8, wherein the predetermined image processing is an expansion/contraction processing.

14. The reading system according to claim 8, wherein the sensor generates the first detection data when the sensor is at a first height and the second detection data when the sensor is at a second height different from the first height.

15. A self-propelled reading system comprising:
a self-propelled robot having an RFID tag reader and a sensor; and
a controller configured to:
generate a first environment map based on first detection data received from the sensor;
convert the first environment map into a second environment map by a predetermined image processing;
generate a third environment map based on second detection data received from the sensor;
convert the third environment map into a fourth environment map by the predetermined image processing;
compare the second environment map with the fourth environment map;
select one of the second environment map and the fourth environment map captures an outline of an object depicted in the second environment map and the fourth environment map according to a comparison result between the second environment map and the fourth environment map; and
control movement of the self-propelled robot according to the selected environment map.

16. The self-propelled reading system according to claim 15, wherein the controller is configured to compare the number of pixels in a first portion of the second environment map that depicts the object with the number of pixels in a second portion of the fourth environment map that depicts the object to generate the comparison result.

17. The self-propelled reading system according to claim 16, wherein the controller is configured to
select the second environment map if the number of pixels in the first portion is greater than the number of pixels in the second portion, and
select the fourth environment map if the number of pixels in the second portion is greater than the number of pixels in the first portion.

18. The self-propelled reading system according to claim 15, the controller is configured to compare the length of an outer periphery of a first portion of the second environment map that depicts the object with the length of an outer periphery of a second portion of the fourth environment map that depicts the object to generate the comparison result.

19. The self-propelled reading system according to claim 18, wherein the controller is configured to
select the second environment map if the length of the outer periphery of the first portion is greater than the length of the outer periphery of the second portion, and
select the fourth environment map if the length of the outer periphery of the second portion is greater than the length of the outer periphery of the first portion.

20. The self-propelled reading system according to claim 15, wherein
the self-propelled robot includes wheels that are driven by a motor, and
the motor is controlled by the controller according to the selected environment map during operation of the RFID reader.
